(19) United States
(12) Patent Application Publication
(10) Pub. No.: US 2026/0341300 A1
(43) Pub. Date: Oct. 29, 2026

(54) COMPUTING SYSTEM AND METHOD FOR DETECTING MEDLEY OF MUSIC

(71) Applicant: Bytedance Technology Ltd., Grand Cayman (KY)

(72) Inventors: Rongrong LIU, Culver City, CA (US); Mingyu LIU, Beijing (CN)

(21) Appl. No.: 19/192,097

(22) Filed: Apr. 28, 2025

(51) Int. Cl. G10L 25/51; G10L 25/30

(52) U.S. Cl. CPC G10L 25/51; G10L 25/30

(57) ABSTRACT

A computing system for detecting a medley of music is provided, including processing circuitry configured to receive audio data and encode the audio data to extract audio features, which are indexed as a time series of the audio data. The processing circuitry is further configured to identify candidate breakpoints in the audio data based on the audio features. The processing circuitry is further configured to input the candidate breakpoints to a trained neural network classifier to thereby classify each of the candidate breakpoints as a music boundary or not a music boundary, where the trained neural network classifier having been trained on a training data set of audio samples. The processing circuitry is further configured to determine, based on the candidate breakpoints labeled as music boundaries, a plurality of audio segments in the audio data, and output an identification of each of the audio segments.

### BACKGROUND

The rise of user-generated content (UGC) platforms coupled with the growing popularity of medley music, which combines segments from multiple songs or multiple compositions, has introduced new challenges in music identification. Medley tracks often feature significant alterations to the original songs, such as changes in pitch, tempo, and arrangement, making them more difficult to identify using traditional music recognition technologies. Traditional song recognition systems, which rely heavily on database matching and audio fingerprinting, struggle with medley tracks because they require pre-storing every segment of the medley and accurately identifying each part. This approach leads to overly complex systems that are difficult to maintain and scale effectively. The challenges of detecting medley music have real world implications for digital platforms, music streaming services, content creators, and rights holders. These stakeholders must navigate the complexities of accurate music identification to ensure proper attribution and compliance with policies, all while maintaining a seamless user experience.

### SUMMARY

A computing system for detecting a medley of music is provided herein. In one example, the computing system includes processing circuitry and memory storing instructions that, during execution, cause the processing circuitry to receive audio data. The processing circuitry is further configured to encode the audio data to extract audio features, which are indexed as a time series of the audio data. The processing circuitry is further configured to identify, via a breakpoint detection algorithm, candidate breakpoints in the audio data based on the audio features. The processing circuitry is further configured to input the candidate breakpoints to a trained neural network classifier to thereby classify each of the candidate breakpoints as a music boundary or not a music boundary. The trained neural network classifier having been trained on a training data set of audio samples, each of the audio samples being labeled as a music boundary or not a music boundary. The processing circuitry is further configured to determine, based on the candidate breakpoints labeled as music boundaries, a plurality of audio segments in the audio data. The processing circuitry is further configured to output an identification of each of the audio segments.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic diagram of an example computing system for detecting a medley of music, according to one example implementation of the present disclosure.

FIG. 2 shows a spectrogram with frequency on the y-axis and time on the x-axis.

FIG. 3 illustrates an example implementation of a trained neural network classifier of the computing system of FIG. 1.

FIG. 4 shows a flowchart of a computerized method for detecting a medley of music according to one example implementation of the computing system of FIG. 1.

FIG. 5 shows an example computing environment of the present disclosure in which the computing system of FIG. 1 may be enacted.

### DETAILED DESCRIPTION

While there are existing music recognition technologies that address some of the identified issues, those based on audio fingerprinting models are particularly ill-suited for detecting medley music. These systems work by matching audio segments to a huge database of known songs, relying on the unique characteristics of the audio to find similarities. However, when it comes to medley tracks, where different songs or compositions are spliced together, altered, or remixed, these traditional methods run into significant limitations.

For example, medley music often involves changes to the original songs' pitch, speed, or rhythmic structure. Audio fingerprinting methods, which are sensitive to such changes, fail to recognize individual song components within the medley, resulting in incorrect or incomplete identification. Furthermore, medley tracks often blend multiple pieces of music into a single, cohesive composition. Some segments are sometimes overlapped partially (at the boundaries) or fully (such as when an extra background beat is added for a DJ mix). Traditional song recognition systems struggle to identify these segmented audio pieces because they weren't originally designed to detect such complex, multi-source content. Finally, existing song databases used for matching audio content must cover a wide range of genres, eras, and styles to be effective. Medley recognition requires databases that not only contain a vast number of songs but also ensure uniqueness in track identification. For example, versions of a song in different tempos or keys must still map to a single, unified song entity. Creating and maintaining this unique and comprehensive database is challenging.

These challenges lead to significant drawbacks in current systems: they are not equipped to handle the variability introduced by medley music, which limits their ability to provide accurate and comprehensive song identification. As a result, detecting medley tracks accurately remains a difficult task, with many existing systems prone to errors when faced with transformed or blended music.

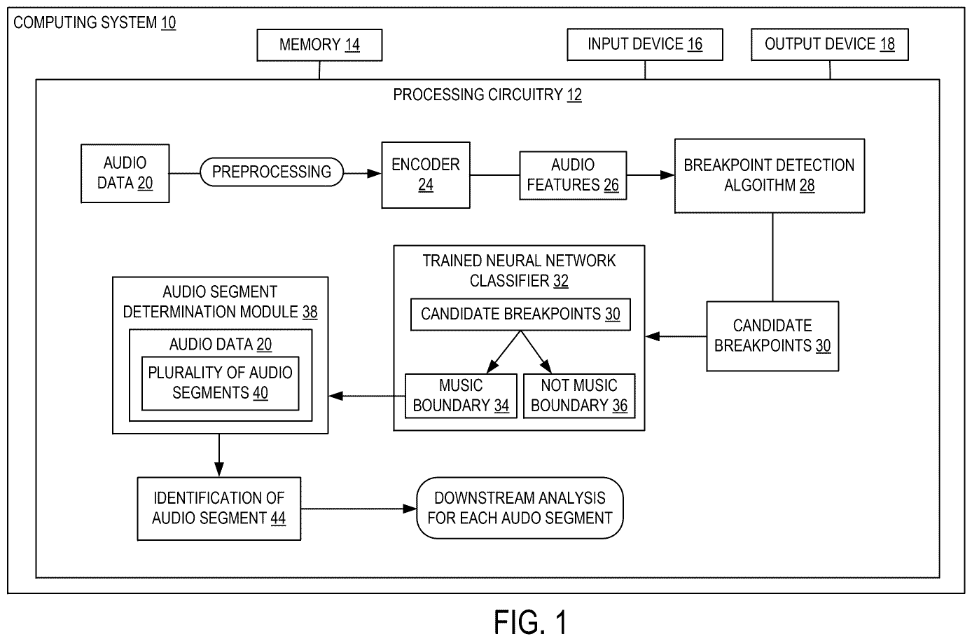

As schematically illustrated in FIG. 1, a computing system 10 is provided to address the issues identified above for detecting medley of music. The computing system 10 comprises processing circuitry 12, memory 14, one or more input devices 16 for receiving user input, and one or more output devices 18, such as a display. The computing system 10 may serve as a client device, which may be a device such as a smartphone, tablet, smartwatch, or personal computer. Furthermore, the computing system 10, including the processing circuitry 12 may be one of a plurality of server devices, and the processing circuitry 12 may be one processor of a single server device or multiple processors of multiple server devices.

The memory 14 stores instructions that, during execution, cause the processing circuitry 12 to receive audio data 20, which may include a spectrogram. The audio data 20 may consist of instrumental tracks, or various genres of music used as background music on a user-generated social media platform. The audio data 20 may be collected from user content and stored on the platform. Additionally, the audio data 20 can be stored on a computing device of a user of the social media platform.

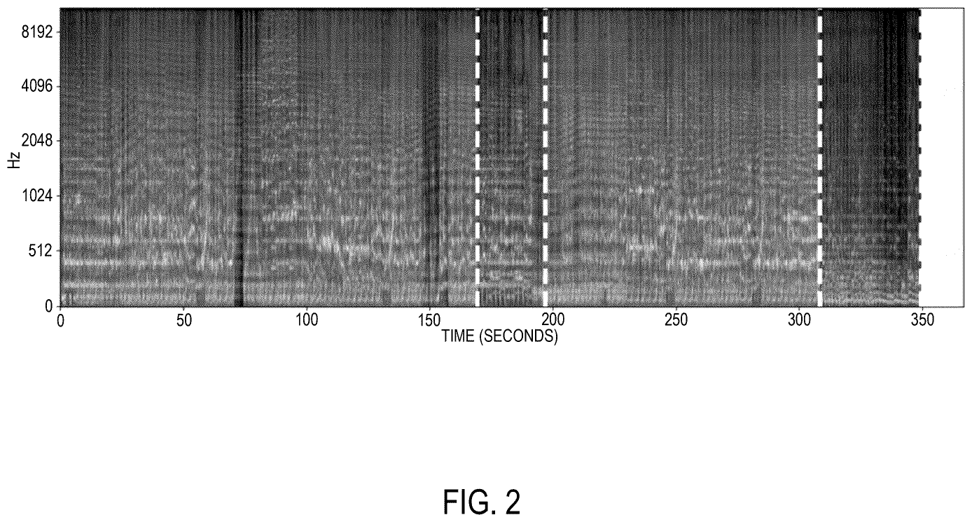

Turning briefly to FIG. 2, FIG. 2 shows a spectrogram with frequency on the y-axis (ranging from 0 Hz to 8192 Hz) and time on the x-axis (ranging from 0 seconds to 350 seconds). The intensity of each pixel represents the amplitude of frequencies at each time point, with brighter pixels indicating higher amplitudes and darker pixels indicating lower amplitudes. There are two distinct vertical dashed lines around the 175-second and 200-second marks, suggesting a significant event or change in the signal within this time interval. Breakpoint analysis as discussed below is performed to identify and characterize these changes in the signal.

Prior to the breakpoint analysis discussed below, the audio data 20 may be preprocessed for efficient breakpoint analysis. While audio signals in their raw waveform form are essentially time series data, they are often too unrefined and lengthy for efficient analysis. To enhance the signal's information content, the raw audio is transformed into a Mel-Spectrogram, which provides a more detailed and informative representation of the signal. Alternatively, other audio representations such as Mel-frequency cepstral coefficients (MFCC) or Constant-Q Transform (CQT) can also be used, or even combined, as long as these representations capture the temporal variations in the audio signal. This transformation results in an input of the form [T, F], where T refers to the number of time steps, and F refers to the number of feature dimensions in the frequency domain.

Furthermore, to improve computational efficiency, a downsampling step is introduced. Specifically, one frame is selected from every N consecutive frames, or alternatively, a pooling operation (either average or max pooling) is applied across each consecutive group of N frames along the time axis. On the frequency axis, depending on the needs of the analysis, a low-pass or high-pass filter may be applied to focus on the frequency ranges that exhibit the most significant changes. These techniques reduce the complexity of subsequent computations, enhancing the overall efficiency of the process.

Once the audio data 20 has been preprocessed into a feature matrix [T, F], the breakpoint detection algorithm 28 is applied to identify the candidate breakpoints 30 (potential segmentation points) in the audio data 20. The processing circuitry 12 is configured to encode, via an encoder 24, the audio data 20 to extract audio features 26, in which the audio features 24 are indexed as a time series of the audio data 20. The processing circuitry 12 is further configured to identify, via a breakpoint detection algorithm 28, candidate breakpoints 30 in the audio data 20 based on the audio features 26 for breakpoint detection. Specifically, the extracted audio features 26 are input to the breakpoint detection algorithm 28 to identify moments where significant changes occur, commonly referred to as change points, in the audio data 20, detecting shifts in the underlying signal or time series. The breakpoint detection algorithm 28 computes variance of the audio features 26 over time and identifies the candidate breakpoints 30 as points in time at which the computed variance changes.

More specifically, the candidate breakpoints 30 are evaluated by a cost function, which is minimized to determine an optimum number of breakpoints in the audio data 20. Formally, given an input sequence [t₁, t₂, . . . , tₙ], the goal of breakpoint detection is to find the optimal segmentation that divides the sequence into intervals, such as [t₁,tₖ_{₁}], [tₖ_{₁},tₖ_{₂}], . . . , [tₖ_{ₙ₋₁},tₙ]. The quality of the segmentation is measured by a cost function:

$$C ( K ) = {\sum }_{k = 0}^{K} c ( {t}_{k} , {t}_{k + 1} )$$

where c(tₖ, tₖ₊₁) quantifies the homogeneity of the signal between two consecutive segments. A low cost indicates that the signal within the segment is relatively homogeneous, while a high cost indicates significant variability. One intuitive method for calculating this cost is using the mean shift approach, where the cost for a segment [tₐ,t_{b}] is computed as:

$$c ( {t}_{a} , {t}_{b} ) = {\sum }_{i = a}^{b} {\vert {t}_{i} - {\overline{t}}_{a … b} \vert}^{2}$$

where t̅_{a . . . b} is the mean of the segment from tₐ to t_{b}.

To determine the optimal number of breakpoints K, optimization techniques such as dynamic programming are used, resulting in a time complexity of O(KT²). More efficient algorithms, such as PELT (Pruned Exact Linear Time), can be used to reduce the time complexity to O(KT), where K is the number of breakpoints and T is the number of time frames.

A critical consideration is the determination of the number of breakpoints K. This can be set empirically based on the typical number of changes expected in a segment of medley music. Alternatively, an automatic search for the optimal K can be conducted using the elbow method. The steps for applying the elbow method are as follows:
(i) Search for K values ranging from 1 to M.
(ii) For each K, perform breakpoint detection and record the corresponding cost.
(iii) Plot the cost as a function of K and identify the “elbow” point, where the cost reduction starts to plateau. The optimal K corresponds to this elbow point. The rationale behind this approach is that as K increases, the cost decreases, but beyond a certain point (the elbow), the rate of cost reduction slows significantly, indicating that adding more breakpoints has diminishing returns on improving segmentation.

It will be appreciated that two primary approaches to change point detection can be utilized: an online method, which detects changes in real-time (useful for real-time processing and anomaly detection) and thus only analyzes a partial dataset for a track up until the current time, and an offline method, which analyzes the complete dataset for a track and benefits from the additional context provided by both preceding and following segments of data surrounding candidate breakpoints. When the complete audio (e.g., a full music track) is available for analysis, the offline method may be better suited as it allows for more accurate segmentation.

Once the candidate breakpoints 30 or the optimal set of breakpoints [tₖ_{₁}, tₖ_{₂}, . . . , tₖ_{ₙ}] are identified, these time points are passed to the next stage of the process. These candidate breakpoints 30 represent the potential boundaries between individual songs in a medley, providing valuable information for further analysis or segmentation. Essentially, the candidate breakpoints 30 indicate moments where significant changes occur in the audio data 20. For instance, these changes can happen within the same song, such as transitioning from a verse to a chorus, or between different songs concatenated together. This problem is framed as a binary classification for each breakpoint, where the task is to determine whether each of the candidate breakpoints 30 truly marks the boundary between two different songs.

To perform the above task, a trained neural network classifier 32 is utilized. The processing circuitry 12 is configured to input the candidate breakpoints 30 to the trained neural network classifier 32 to thereby classify each of the candidate breakpoints 30 as a music boundary 34 or not a music boundary 36. The music boundary 34 may be a song boundary a transition between different sections within a single composition, such as from a verse to a chorus or from one movement to another in a classical piece. The trained neural network classifier 32 is trained to classify the audio data 20 as the music boundary when a confidence score of the classifier is greater than a threshold probability.

The trained neural network classifier 32 has been trained on a training data set of audio samples, in which each of the audio samples is labeled as a music boundary 34 or not a music boundary 36. Furthermore, the audio samples in the training data are encoded by an audio encoder to thereby extract the time series of the audio features for each of the audio samples. The extracted time series of the audio features is provided as input into the classifier at training time.

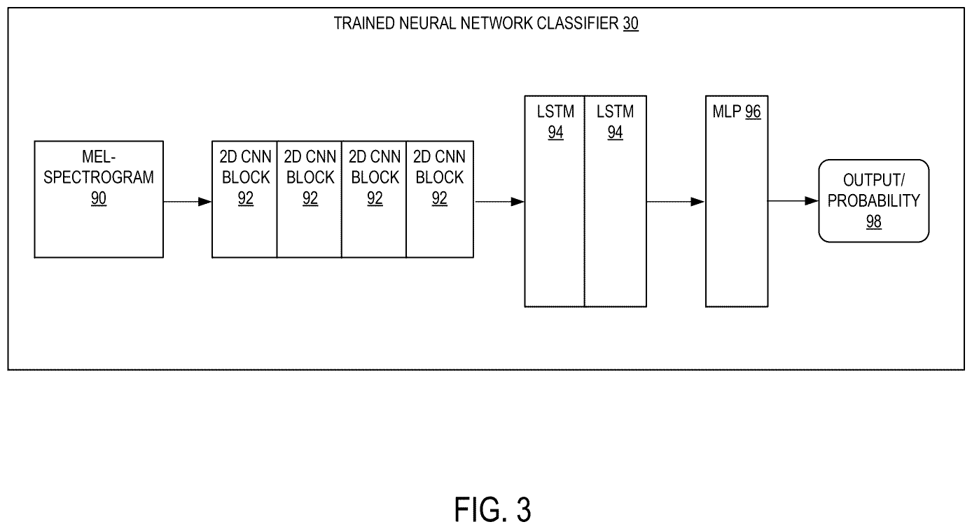

FIG. 3 shows an example structure of the trained neural network classifier 32 of the computing system 10 of FIG. 1. The trained neural network classifier 32 may be based on a neural network architecture. For example, a recurrent neural network architecture can be used. In one specific example, the trained neural network classifier may be based on a Convolutional Recurrent Neural Network (CRNN).

In the depicted example of FIG. 3, a sequence of processing stages within the CRNN architecture is illustrated. The input to the neural network is a Mel-Spectrogram 90, which represents the audio data 20 transformed into a visual format that captures the frequency content over time. The Mel-Spectrogram is processed through consecutive 2D CNN (Convolutional Neural Network) blocks 92. These blocks 92 apply two-dimensional convolutional layers to extract relevant features from the spectrogram 90, enhancing the representation of the audio signal. Following the convolutional blocks 92, the extracted features are fed into LSTM (Long Short-Term Memory) layers 94. These layers 94 are designed to handle sequential data and capture temporal dependencies, which are crucial for understanding the progression of the audio signal over time. After the LSTM layers 94, the data is further processed by an MLP (Multi-Layer Perceptron) layer 96. This MLP layer 96 performs additional computations to refine the features and prepare them for classification. The final stage is an output layer 98, which provides the classification probabilities, indicating the likelihood of different classes. These probabilities help determine the boundaries between different music segments. For instance, if the probability is low (i.e., below a threshold confidence level), the clip is considered part of a single song.

The probability scores are calculated for all candidate breakpoints 30. After calculating the probability scores for all breakpoints, the maximum score is selected as the final score for the entire song (considered as a medley):

$${Score}_{song} = {max}_{k ∈ [ 1 , K ]} {score}_{k}$$

Any breakpoint with a score above a predefined threshold is identified as the music boundary between two distinct songs or music segments. The processing circuitry 12 is configured to determine, based on the candidate breakpoints labeled as music boundaries 34, a plurality of audio segments 40 in the audio data 20 via an audio segment determination module 38. The processing circuitry 12 is further configured to output an identification of each of the audio segments 44 for downstream analysis for each audio segment.

With the boundaries of each music segment now detected, the original track can be divided into individual segments for further analysis. For instance, when the audio data 20 corresponds to media content published on a social media platform, the social media platform may include a policy enforcement engine that is configured to enforce one or more content policies on the media content hosted on the social media platform. When the media content contains the audio data 20 that corresponds to the medley of music, each of the audio segments is examined individually for policy compliance at the policy enforcement engine of the social media platform. Audio segments determined by the policy enforcement engine to not comply with platform policies, will be flagged for human review, programmatically refused publication, programmatically removed, or programmatically labeled with a compliance failure notice, for example.

Furthermore, each segment can be processed through music fingerprinting systems or cover song detection algorithms. The results from these systems can help refine the previous step by filtering out potential errors. For example, if the music fingerprint of two consecutive segments matches a single song in the fingerprint database, this could indicate a misclassification in boundary detection, signaling the need for error correction. Additionally, detailed metadata can be generated for each segment, including the start and end times, as well as how each segment maps back to the original music. This is particularly useful when dealing with clips or fragments, as it provides contextual information on how the segment fits within the broader structure of the original track. Such detailed segment-level data can be leveraged for a range of downstream applications, including copyright management (e.g., identifying and removing unlicensed music) or ensuring compliance with music usage regulations (e.g., detecting and removing non-compliant content).

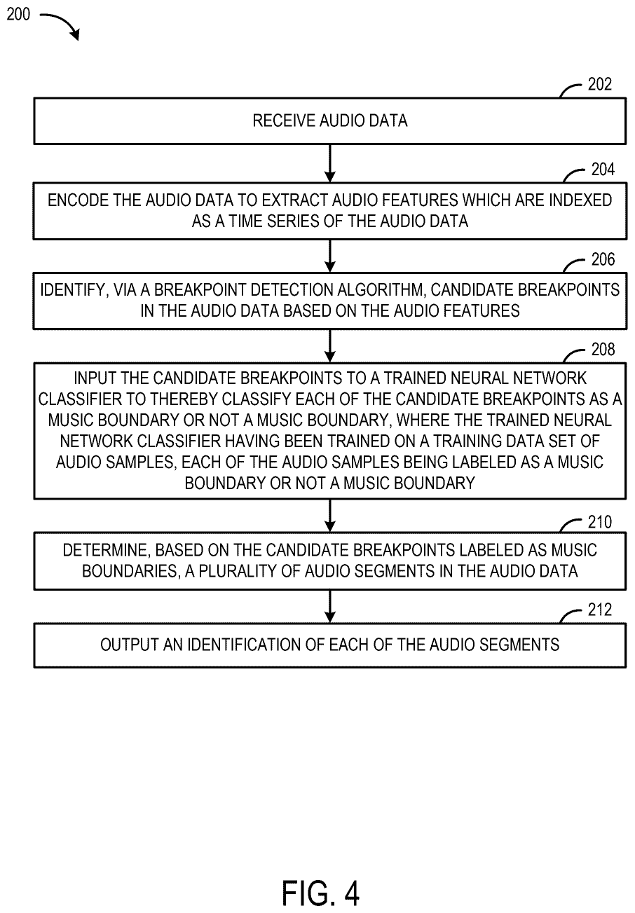

FIG. 4 shows a flowchart of a computerized method 200 for detecting a medley of music according to one example implementation of the computing system 10 of FIG. 1. At step 202, the method may include receiving audio data. At step 204, the method may include encoding the audio data to extract audio features, in which the audio features are indexed as a time series of the audio data. At step 206, the method may include identifying, via a breakpoint detection algorithm, candidate breakpoints in the audio data based on the audio features.

At step 208, the method may include inputting the candidate breakpoints to a trained neural network classifier to thereby classify each of the candidate breakpoints as a music boundary or not a music boundary. The trained neural network classifier having been trained on a training data set of audio samples, each of the audio samples being labeled as a music boundary or not a music boundary. At step 210, the method may include determining, based on the candidate breakpoints labeled as music boundaries, a plurality of audio segments in the audio data. At step 212, the method may output an identification of each of the audio segments.

The above-described system and method enhance the accuracy and flexibility of medley detection by focusing on identifying the boundaries between different musical sections within a medley, regardless of the transformations applied to the original songs or music. This improvement enables digital platforms, content creators, and copyright holders to more effectively manage and protect their music, ensuring accurate identification and crediting of both original and derivative works.

In some embodiments, the methods and processes described herein may be tied to a computing system of one or more computing devices. In particular, such methods and processes may be implemented as a computer-application program or service, an application-programming interface (API), a library, and/or other computer-program product.

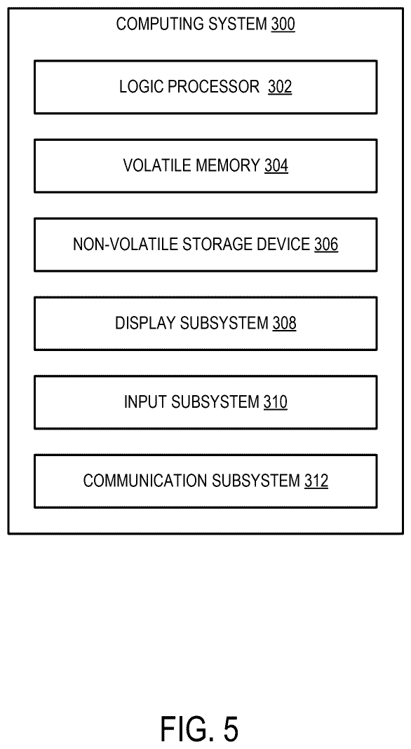

FIG. 5 schematically shows a non-limiting embodiment of a computing system 300 that can enact one or more of the methods and processes described above. Computing system 300 is shown in simplified form. Computing system 300 may embody the computing system 10 described above and illustrated in FIG. 1. Components of computing system 300 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 300 includes a logic processor 302 volatile memory 304, and a non-volatile storage device 306. Computing system 300 may optionally include a display subsystem 308, input subsystem 310, communication subsystem 312, and/or other components not shown in FIG. 5.

Logic processor 302 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the logic processor 302 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 306 includes one or more physical devices configured to hold instructions executable by the logic processors to implement the methods and processes described herein. When such methods and processes are implemented, the state of non-volatile storage device 306 may be transformed—e.g., to hold different data.

Non-volatile storage device 306 may include physical devices that are removable and/or built in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by logic processor 302 to temporarily store information during processing of software instructions. It will be appreciated that volatile memory 304 typically does not continue to store instructions when power is cut to the volatile memory 304.

Aspects of logic processor 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via logic processor 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). As the herein described methods and processes change the data held by the non-volatile storage device, and thus transform the state of the non-volatile storage device, the state of display subsystem 308 may likewise be transformed to visually represent changes in the underlying data. Display subsystem 308 may include one or more display devices utilizing virtually any type of technology. Such display devices may be combined with logic processor 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, camera, or microphone.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 300 to send and/or receive messages to and/or from other devices via a network such as the Internet.

The following paragraphs provide additional description of the subject matter of the present disclosure. One aspect provides a computing system for detecting a medley of music comprising processing circuitry and memory storing instructions that, during execution, cause the processing circuitry to receive audio data. The processing circuitry is further configured to encode the audio data to extract audio features, in which the audio features are indexed as a time series of the audio data. The processing circuitry is further configured to identify, via a breakpoint detection algorithm, candidate breakpoints in the audio data based on the audio features. The processing circuitry is further configured to input the candidate breakpoints to a trained neural network classifier to thereby classify each of the candidate breakpoints as a music boundary or not a music boundary, where the trained neural network classifier has been trained on a training data set of audio samples, each of the audio samples being labeled as a music boundary or not a music boundary. The processing circuitry is further configured to determine, based on the candidate breakpoints labeled as music boundaries, a plurality of audio segments in the audio data. The processing circuitry is further configured to output an identification of each of the audio segments.

In this aspect, the breakpoint detection algorithm computes variance of the audio features over time and identifies the candidate breakpoints as points in time at which the computed variance changes.

In this aspect, the candidate breakpoints are evaluated by a cost function, which is minimized to determine an optimum number of breakpoints in the audio data.

In this aspect, the trained neural network classifier is trained to classify the audio data as the music boundary when a confidence score of the classifier is greater than a threshold probability.

In this aspect, the audio samples in the training data are encoded by an audio encoder to extract the time series of the audio features for each of the audio samples and the extracted time series of the audio features is provided as input into the classifier at training time.

In this aspect, the audio data includes a spectrogram.

In this aspect, the audio data corresponds to media content published on a social media platform, and the social media platform including a policy enforcement engine is configured to enforce one or more content policies on the media content hosted on the social media platform.

In this aspect, when the media content contains the audio data that corresponds to the medley of music, each of the audio segments is examined individually for policy compliance at the policy enforcement engine of the social media platform.

In this aspect, the trained neural network classifier is based on a Convolutional Recurrent Neural Network (CRNN).

Another aspect provides a computerized method for detecting a medley of music. The method comprises encoding the audio data to extract audio features, in which the audio features are indexed as a time series of the audio data. The method further comprises identifying, via a breakpoint detection algorithm, candidate breakpoints in the audio data based on the audio features. The method further comprises inputting the candidate breakpoints to a trained neural network classifier to thereby classify each of the candidate breakpoints as a music boundary or not a music boundary, where the trained neural network classifier has been trained on a training data set of audio samples, each of the audio samples being labeled as a music boundary or not a music boundary. The method further comprises determining, based on the candidate breakpoints labeled as music boundaries, a plurality of audio segments in the audio data. The method further comprises outputting an identification of each of the audio segment.

In this aspect, the breakpoint detection algorithm computes variance of the audio features over time and identifies the candidate breakpoints as points in time at which the computed variance changes.

In this aspect, the candidate breakpoints are evaluated by a cost function, which is minimized to determine an optimum number of breakpoints in the audio data.

In this aspect, the trained neural network classifier is trained to classify the audio data as the music boundary when a confidence score of the classifier is greater than a threshold probability.

In this aspect, the audio samples in the training data are encoded by an audio encoder to extract the time series of the audio features for each of the audio samples and the extracted time series of the audio features is provided as input into the classifier at training time.

In this aspect, the audio data corresponds to media content published on a social media platform, and the social media platform including a policy enforcement engine is configured to enforce one or more content policies on the media content hosted on the social media platform.

In this aspect, when the media content contains the audio data that corresponds to the medley of music, each of the audio segments is examined individually for policy compliance at the policy enforcement engine of the social media platform.

In this aspect, the audio data includes a spectrogram.

In this aspect, the trained neural network classifier is based on a Convolutional Recurrent Neural Network (CRNN).

Another aspect provides a non-transitory computer readable medium including instructions stored thereon. In this aspect, the instructions, when executed by processing circuitry, cause the processor to execute the following steps. The processor is configured to execute the step of receiving audio data. The processor is further configured to execute the step of encoding the audio data to extract audio features, in which the audio features are indexed as a time series of the audio data. The processor is further configured to execute the step of identifying, via a breakpoint detection algorithm, candidate breakpoints in the audio data based on the audio features. The processor is further configured to execute the step of inputting the candidate breakpoints to a trained neural network classifier to thereby classify each of the candidate breakpoints as a music boundary or not a music boundary, where the trained neural network classifier has been trained on a training data set of audio samples, each of the audio samples being labeled as a music boundary or not a music boundary. The processor is further configured to execute the step of determining, based on the candidate breakpoints labeled as music boundaries, a plurality of audio segments in the audio data. The processor is further configured to execute the step of outputting an identification of each of the audio segments.

In this aspect, the breakpoint detection algorithm computes variance of the audio features over time and identifies the candidate breakpoints as points in time at which the computed variance changes.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system for detecting a medley of music, comprising:
processing circuitry and memory storing instructions that, during execution, cause the processing circuitry to:
receive audio data;
encode the audio data to extract audio features, the audio features being indexed as a time series of the audio data;
identify, via a breakpoint detection algorithm, candidate breakpoints in the audio data based on the audio features;
input the candidate breakpoints to a trained neural network classifier to thereby classify each of the candidate breakpoints as a music boundary or not a music boundary, the trained neural network classifier having been trained on a training data set of audio samples, each of the audio samples being labeled as a music boundary or not a music boundary;
determine, based on the candidate breakpoints labeled as music boundaries, a plurality of audio segments in the audio data; and
output an identification of each of the audio segments.

2. The computing system of claim 1, wherein
the breakpoint detection algorithm computes variance of the audio features over time and identifies the candidate breakpoints as points in time at which the computed variance changes.

3. The computing system of claim 2, wherein
the candidate breakpoints are evaluated by a cost function, which is minimized to determine an optimum number of breakpoints in the audio data.

4. The computing system of claim 1, wherein
the trained neural network classifier is trained to classify the audio data as the music boundary when a confidence score of the classifier is greater than a threshold probability.

5. The computing system of claim 1, wherein
the audio samples in the training data are encoded by an audio encoder to extract the time series of the audio features for each of the audio samples and the extracted time series of the audio features is provided as input into the classifier at training time.

6. The computing system of claim 1, wherein
the audio data includes a spectrogram.

7. The computing system of claim 1, wherein
the audio data corresponds to media content published on a social media platform, and the social media platform including a policy enforcement engine is configured to enforce one or more content policies on the media content hosted on the social media platform.

8. The computing system of claim 7, wherein
when the media content contains the audio data that corresponds to the medley of music, each of the audio segments is examined individually for policy compliance at the policy enforcement engine of the social media platform.

9. The computing system of claim 1, wherein
the trained neural network classifier is based on a Convolutional Recurrent Neural Network (CRNN).

10. A computerized method for detecting a medley of music, comprising:
receiving audio data;
encoding the audio data to extract audio features, the audio features being indexed as a time series of the audio data;
identifying, via a breakpoint detection algorithm, candidate breakpoints in the audio data based on the audio features;
inputting the candidate breakpoints to a trained neural network classifier to thereby classify each of the candidate breakpoints as a music boundary or not a music boundary, the trained neural network classifier having been trained on a training data set of audio samples, each of the audio samples being labeled as a music boundary or not a music boundary;
determining, based on the candidate breakpoints labeled as music boundaries, a plurality of audio segments in the audio data; and
outputting an identification of each of the audio segments.

11. The computerized method of claim 10, wherein
the breakpoint detection algorithm computes variance of the audio features over time and identifies the candidate breakpoints as points in time at which the computed variance changes.

12. The computerized method of claim 11, wherein
the candidate breakpoints are evaluated by a cost function, which is minimized to determine an optimum number of breakpoints in the audio data.

13. The computerized method of claim 12, wherein
the trained neural network classifier is trained to classify the audio data as the music boundary when a confidence score of the classifier is greater than a threshold probability.

14. The computerized method of claim 12, wherein
the audio samples in the training data are encoded by an audio encoder to extract the time series of the audio features for each of the audio samples and the extracted time series of the audio features is provided as input into the classifier at training time.

15. The computerized method of claim 10, wherein
the audio data corresponds to media content published on a social media platform, and the social media platform including a policy enforcement engine is configured to enforce one or more content policies on the media content hosted on the social media platform.

16. The computerized method of claim 15, wherein
when the media content contains the audio data that corresponds to the medley of music, each of the audio segments is examined individually for policy compliance at the policy enforcement engine of the social media platform.

17. The computerized method of claim 10, wherein
the audio data includes a spectrogram.

18. The computerized method of claim 10, wherein
the trained neural network classifier is based on a Convolutional Recurrent Neural Network (CRNN).

19. A non-transitory computer readable medium including instructions stored thereon, the instructions, when executed by processing circuitry, causing the processor to execute steps of:
receiving audio data;
encoding the audio data to extract audio features, the audio features being indexed as a time series of the audio data;
identifying, via a breakpoint detection algorithm, candidate breakpoints in the audio data based on the audio features;
inputting the candidate breakpoints to a trained neural network classifier to thereby classify each of the candidate breakpoints as a music boundary or not a music boundary, the trained neural network classifier having been trained on a training data set of audio samples, each of the audio samples being labeled as a music boundary or not a music boundary;
determining, based on the candidate breakpoints labeled as music boundaries, a plurality of audio segments in the audio data; and
outputting an identification of each of the audio segments.

20. The non-transitory computer readable medium of claim 19, wherein
the breakpoint detection algorithm computes variance of the audio features over time and identifies the candidate breakpoints as points in time at which the computed variance changes.
